(19) United States
(12) Patent Application Publication
(10) Pub. No.: US 2019/0366745 A1
(43) Pub. Date: Dec. 5, 2019

(54) TRAY GUIDE LOCKS

(71) Applicant: Hewlett-Packard Development Company, L.P., Houston, TX (US)

(72) Inventors: Michael Evan Daniels, Boise, ID (US); William L. Cornelius, Boise, ID (US)

(21) Appl. No.: 15/994,157

(22) Filed: May 31, 2018

(51) Int. Cl. B41J 13/10; B65H 1/04

(52) U.S. Cl. CPC B41J 13/103; B65H 2553/61; B65H 2511/10; B65H 1/04

(57) ABSTRACT

In an example, an apparatus may include a tray guide to support print media, a plurality of side guides to adjust a dimension of the tray guide when side fastening mechanisms corresponding to each of the plurality of side guides are actuated. Where adjusting the dimension of the tray guide alters a repository area disposed within the tray to support print media of a particular size, and a plurality of side tray guide locks to prevent corresponding side guides among the plurality of side guides from adjustment.

### BACKGROUND

A printing device may be used to process and output a physical medium. For example, a printing device may perform a print job comprising printing text and/or graphics by transferring ink, toner, and/or other material to the physical medium.

### BRIEF DESCRIPTION OF THE DRAWINGS

FIG. 1 illustrates an example of an apparatus including fastening mechanisms to receive tray guide locks consistent with the present disclosure.

FIG. 2 illustrates an example of tray guide locks consistent with the present disclosure.

FIG. 3A illustrates an example apparatus including a tray guide lock consistent with the disclosure.

FIG. 3B illustrates another example apparatus including a tray guide lock consistent with the disclosure.

FIG. 3C illustrates an example apparatus including a side guide cover consistent with the disclosure.

FIG. 3D illustrates another example apparatus including a side guide cover consistent with the disclosure.

FIG. 4A illustrates an example apparatus including a tray guide lock consistent with the disclosure.

FIG. 4B illustrates another example apparatus including a tray guide lock consistent with the disclosure.

FIG. 4C illustrates an example apparatus including a rear guide cover consistent with the disclosure.

FIG. 4D illustrates another example apparatus including a rear guide cover consistent with the disclosure.

FIG. 5 illustrates an example of a system including a tray guide lock consistent with the disclosure.

### DETAILED DESCRIPTION

Printing devices such as toner-based printers (e.g., laser printers), liquid-based printers (e.g., inkjet printers), solid ink printers, thermal printers, etc. may provide persistent human-readable representation of graphics and/or text on print media. Print media may be paper, canvas, and/or transparency paper, among others. Print media may be offered in a variety of sizes such as letter sized (e.g., 216 mm×279 mm), A4 (e.g., 210 mm×270 mm), foolscap sized (e.g., 203 mm×330 mm), and/or legal sized (e.g., 216 mm×356 mm), etc.

In some approaches, a printing device may be provided with a capability to print graphics and/or text using different sizes of print media. For example, a printing device may be provided with the capability to print graphics and/or text on letter sized print media and A4 sized print media, among other combinations of print media sizes. Stated alternatively, the printing device may include a tray that may support different sizes of print media.

For example, some printing devices may include a tray that is designed to support letter sized print media and A4 sized print media, however, various adapters and/or extensible portions may allow for the tray to support additional sizes of print media (e.g., legal sized print media and/or foolscap sized print media). However, in some approaches, trays may include mechanisms (e.g., buttons, clips, etc.) to permit a print media repository area of the tray to be altered to easily to accept print media of various sizes. The ease of which the print media repository area may be altered may result in inadvertent error while filling the print media repository area with print media.

For example, a printing device include a tray that is intended to be dedicated to a particular size of print media. For example, a tray may be dedicated to be stocked with A4 sized print media, and because of the ease at which the repository area may be altered, the repository area may be altered to accept letter sized print media. As such, a user may inadvertently change the print repository area to accommodate the letter sized print media. This may result in a user intending to execute a print job using A4 print media and instead receiving the print job output on the letter sized print media.

In some examples, a user of a printing device may become distracted at some point in time and may inadvertently alter a size of the print repository area before or during a print job. This may result in failures of print jobs and/or wasted resources such as print media and/or printing materials. Even it situations in which a user is not distracted, accidental alteration of the size of the print repository may result in wasted time and/or resources, which may result in increased overhead costs and/or decreased production.

Further, in some approaches, mechanism locks may be utilized to prevent the inadvertent alteration of a print media repository area utilizing screws, fasteners, adhesives, and the like. Locking mechanisms such as those mentioned may demand tools for installation. The inconvenience associated with the installation of the aforementioned locks may result in inconsistent installation, and inconsistent use on printing devices with an expectation of consistent containment of a particular size of print media in comparison with examples of the present disclosure.

In contrast, examples herein may allow for a tray repository area to be locked to a particular size for consistent use of the printing device with a particular size of print media utilizing tray guide locks. For example, certain printing device environments may include a designated printing device that is stocked (e.g., filled with) with letter size print media. To prevent the inadvertent alteration of the print media repository area within the tray of the letter sized designated printer, tray guide locks may be connected to portions of the tray. Tray guide locks may improve performance of a printing device by reducing errant print jobs introduced by inadvertent alteration of the print media repository by, for example, an incompetent or impaired user of the printing device. In some examples, the tray guide locks may be installed without the use of tools such that the installation is easy and/or intuitive. This may allow for a layman to install tray guide locks in the absence of a more sophisticated user.

In some examples, different types of tray guide locks may be used together to allow some changes in dimensions of the print media repository area while preventing other changes in different dimensions. For example, tray guide locks may allow a length of the print repository area to change while preventing a width corresponding thereto from changing). When tray guide locks are installed in the tray of a printing device the mechanism which allows the alteration of the print media repository area may be obstructed, this may alert the user attempting to alter the size of the print media repository area that they may be attempting to alter a printer designated to a particular size of print media. Thus, preventing the alteration of the repository area and/or providing an alert to inform a user that the print repository area may be changed.

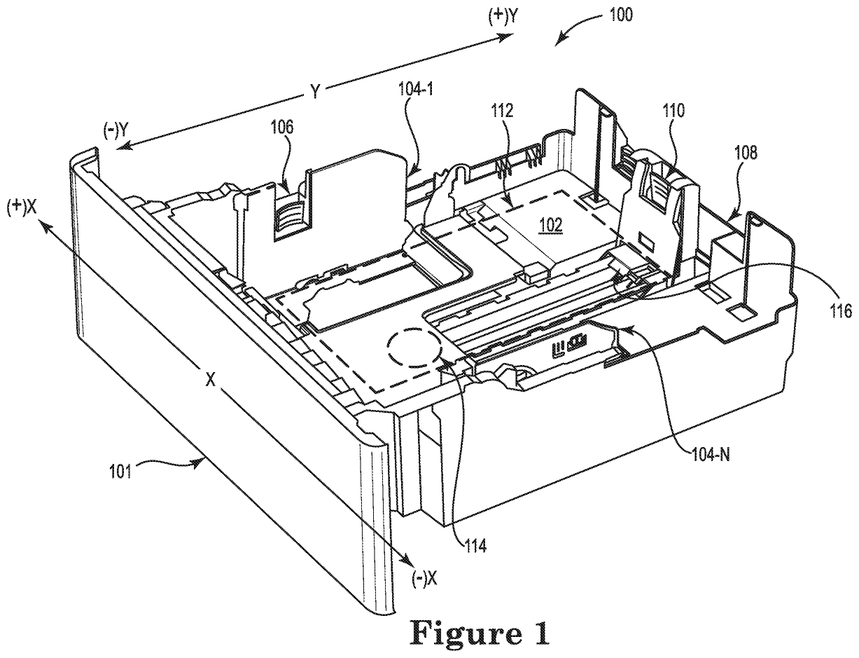

FIG. 1 illustrates an example of an apparatus 100 including side fastening mechanism 106 to receive tray guide locks consistent with the present disclosure. Some elements of the apparatus 100 may be illustrated as having a single element, it should be understood that the apparatus 100 may include more than one of such elements, and the examples should not be interpreted in a limiting sense. For example, FIG. 1 illustrates a single side fastening mechanism 106. Although illustrated as a single side fastening mechanism 106 in FIG. 1, examples are not so limited and multiple fastening mechanisms are contemplated in the present disclosure.

As shown in FIG. 1, the apparatus 100 may include a tray 101 which may include a tray guide 102 to support print media. As used herein, the term “tray” refers to a moveable device that may be stored within a printing device to contain different sizes of print media for use as physical output in a print job, and a “tray guide” refers to a portion of the tray 101 that may be adjusted in dimension to keep print media in an aligned stack. The tray guide 102 may include a plurality of side guides 104-1, . . . , 104-N, a plurality of side fastening mechanisms 106, a rear guide 108, a rear fastening mechanism 110, a side adjustment mechanism 114, a rear adjustment mechanism 116, and a repository area 112. As used herein, the plurality of side guides 104-1, . . . , 104-N may be collectively referred to as the side guides 104. The side guides 104 may adjust a dimension of the tray guide 102 when side fastening mechanisms 106 corresponding to each of the side guides 104 are actuated. Examples are not so limited, however, and the side fastening mechanisms 106 may correspond to some of the side guides without corresponding to each discrete side guide 104-1, . . . , 104-N of the side guides 104. For example, a particular side fastening mechanism 106 may correspond to a particular side guide (e.g., side guide 104-1) without other side fastening mechanisms 106 corresponding to a different particular side guide (e.g., side guide 104-N). The tray 101, the tray guide 102, the side guides 104, the rear guide 108, the rear fastening mechanism 110, the side adjustment mechanism 114, the rear adjustment mechanism 116, and/or the repository 112 may be separately considered an “apparatus.”

The dimensions of the repository area 112, as illustrated in FIG. 1, may be adjusted when the rear guide 108 and/or the side guides 104 are altered. For example, the dimensions of the tray guide 102 may be adjusted to accommodate different sizes of print media. As used herein, the term “repository area” refers to an area within the tray guide 102 where print media may be stored for use by a printing device and adjusting the dimension of the tray guide 120 alters the repository area 112 disposed within the tray to support print media of a particular size. For example, the repository area 112 may be set to accommodate a particular size of print media by adjusting a dimension of the tray guide 102. The dimension of the tray guide 102 may be adjusted by actuating side fastening mechanisms 106 corresponding to side guides 104 or actuating a rear fastening mechanism 110 corresponding to the rear guide 108 or a combination thereof.

As used herein, the term “side guide” refers to a portion of the tray guide 102 that may move to accommodate different dimensions of print media when a side fastening mechanism 106 is actuated. For example, side guide 104-1 may move from the positive x direction (e.g., along a first lateral dimension) toward the negative x direction when the side fastening mechanism 106 is actuated, and the side guide 104-N may move from the negative x direction toward the positive x direction when a different side fastening mechanism 106 (not expressly illustrated by FIG. 1) corresponding to the side guide 104-N is actuated. As such, the dimensions of the tray guide 102 and the repository area 112 may be adjusted along the x axis, as illustrated by the directional coordinates in FIG. 1.

In some examples, the dimension of the tray guide 102 and the repository area 112 may be adjusted along they axis (e.g., along a second lateral dimension). For example, the rear guide 108 may move from the positive y direction toward the negative y direction when the rear fastening mechanism 110 is actuated. As such, the dimensions of the tray guide 102 and the repository area 112 may be adjusted along the y axis, as illustrated by the directional coordinates in FIG. 1. The rear guide 108 and the side guides 104 may be used independently or together to adjust the dimensions of the tray guide 102 and the repository area 112. The side fastening mechanism 106, when actuated, may permit the movement of the side adjustment mechanism 114 to adjust a dimension of the tray guide and the repository area.

As used herein, the term “side fastening mechanism” refers to a mechanical and/or electrical mechanism that when actuated or de-actuated permits or impedes movement of an object to which the side fastening mechanism is coupled to or decoupled from. In some examples, a side fastening mechanism is a mechanical and/or electrical mechanism that may permit or allow movement of the side guides 104 based on whether the side fastening mechanism is actuated or de-actuated. Non-limiting examples of side fastening mechanisms such as side fastening mechanism 106 may include a button, a switch, a depression, a nut, a bolt, a screw, a pin, a rivet, a nail, and the like, as well as combinations thereof, that, when actuated or de-actuated allow the side adjustment mechanism 114 to move the side guides 104 to change the dimension of the tray guide 102.

Likewise, as used herein, the term “rear fastening mechanism” refers to a mechanical and/or electrical mechanism that when actuated or de-actuated permits or impede the movement of the rear guide 108. For example, a rear fastening mechanism 110 may include a button, a switch, a depression, a nut, a bolt, a screw, a pin, a rivet, a nail, and the like, as well as combinations thereof, that, when actuated or de-actuated allow the rear adjustment mechanism 116 to move the rear guide 108 to change the dimension of the tray guide 102.

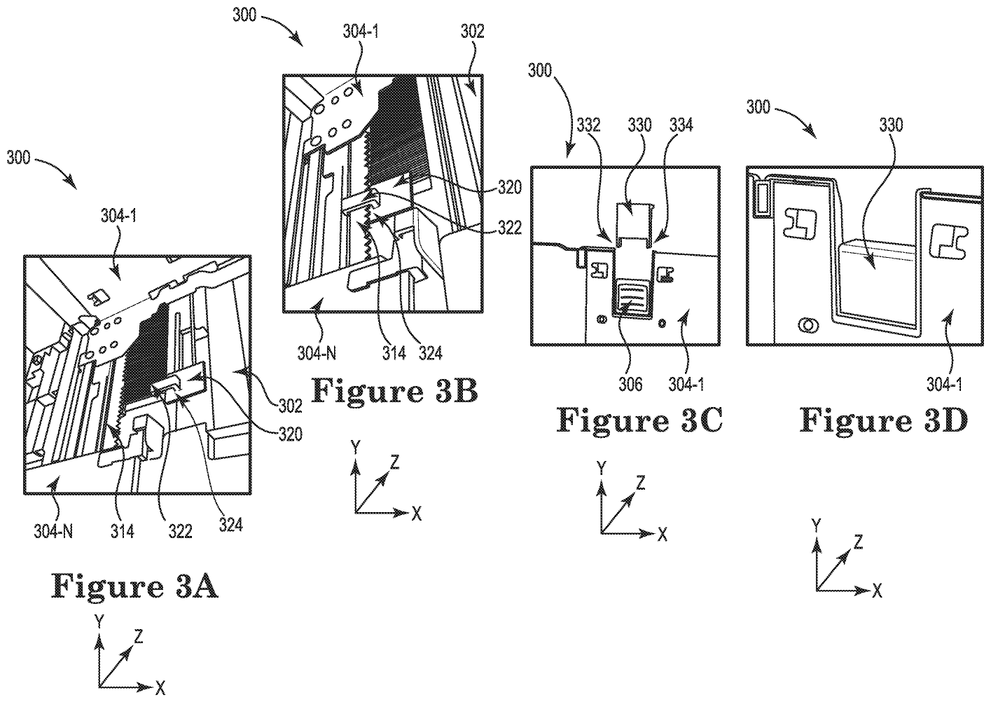

Although not shown in FIG. 1, for clarity and so as not to obscure examples of the disclosure, the side adjustment mechanism 114 may be located under the side guides 104 as will be appreciated in greater detail when described in connection with FIGS. 3A, and 3B. As used herein, the term “side adjustment mechanism” refers to a component of the apparatus 100 that may mechanically or electronically move the side guides 104 along the x axis in a substantially horizontal manner to adjust the dimensions of the tray guide 102. The side adjustment mechanism may be a gear, a rack and pinion, and/or a similar mechanism. For example, actuation or de-actuation of the side fastening mechanism 106 may allow the side adjustment mechanism 114 to facilitate or impede the movement of the side guides 104 to adjust the dimension of the tray guide 102 along the x axis.

Likewise, as used herein, the term “rear adjustment mechanism” refers to a component of the apparatus 100 that may mechanically or electronically move the rear guide 108 along the y axis in a substantially horizontal manner to adjust the dimensions of the tray guide 102. For example, actuation or de-actuation of the rear fastening mechanism 110 may allow the rear adjustment mechanism 116 to allow or impede movement of the rear guide 108 to adjust the dimension of the tray guide 102 along they axis.

As used herein, the term “substantially” may refer to a condition that is not absolute but is near enough to being absolute such that the condition is satisfied. For example, substantially horizontal may refer to a condition that is near enough to being absolutely horizontal that the condition of horizontally is satisfied. Similarly, substantially moved along an axis may refer to a condition that is near enough to being absolutely along an axis that the condition of movement along the axis is satisfied. In some examples, the side fastening mechanism 106 and/or the rear fastening mechanism 110 may be actuated easily to move the side guides 104 and the rear guide 108 along respective dimensions (e.g., their respective axes) in a substantially horizontal manner to adjust the dimension of the tray guide 102. This may allow a feeble, incompetent, and/or distracted user to actuate the side fastening mechanism 106 and/or the rear guide 108 to adjust a dimension of the tray guide inadvertently.

As mentioned, some environments may include printing devices with print media trays (e.g., the tray 101) that are intended to be dedicated to a particular size of print media. For example, the tray 101 may be dedicated to letter sized print media and intended to be stocked with letter sized print media such that a user may expect letter sized print media as an output of a print job when the tray 101 is operated. Because the side fastening mechanism 106 and the rear fastening mechanism 110 may be easily actuated, the tray guide 102 may be adjusted easily and/or inadvertently. For example, an adjustment to the repository area 112 of a print tray 101 to stock A4 sized print media instead of letter sized print media may be easily accomplished by actuating the side fastening mechanism 106 and the rear fastening mechanism 110. To prevent a designated print media tray 101 from an alteration of a corresponding repository area 112, tray guide locks may be utilized to prevent the repository area 112 from being stocked with print media that is of a different size (e.g., A4) than the print media size (e.g., letter) which may be designated to the tray 101.

As shown in FIG. 1, the apparatus 100 and a tray 101 with a tray guide 102 including a repository area 112 which may have its dimensions adjusted to accommodate various sizes of print media by actuating side fastening mechanisms 106 to allow the movement of side guides 104 by the side adjustment mechanism 114. Likewise, the repository area 112 may have its dimensions adjusted by actuating rear fastening mechanisms 110 to allow the movement of rear guide 108 by the rear adjustment mechanism 116. To maintain the tray guide 102 and the repository area 112 at a consistent dimension for a tray 101 that has been designated for a particular size of print media, tray guide locks corresponding to components of the tray guide 102 may be installed onto the tray 101.

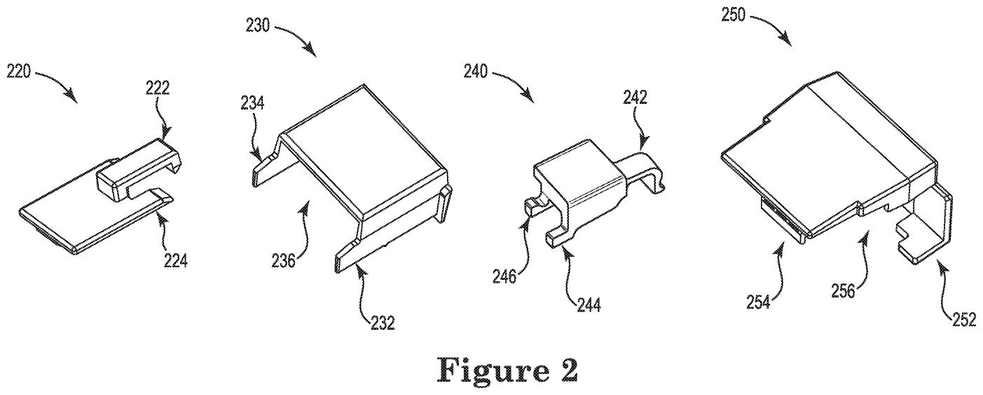

FIG. 2 illustrates an example of tray guide locks consistent with the present disclosure. Tray guide locks, as illustrated in FIG. 2 may be described herein with reference to elements described in connection with FIG. 1.

For example, FIG. 2 illustrates a side tray guide lock 220, a side guide cover 230, a rear tray guide lock 240, and a rear guide cover 250. Although the tray guide locks 220, 230, 240, and 250 are illustrated in FIG. 2 as single elements, examples are not so limited and multiple tray guide locks are contemplated in the present disclosure. For example, FIG. 2 illustrates an individual side tray guide lock 220, however, examples described in the disclosure may include multiple side tray guide locks 220.

The side tray guide lock 220, illustrated by FIG. 2 includes a top lip portion 222 and a bottom lip portion 224. For example, the side tray guide lock 220 may comprise the top lip portion 222 and the bottom lip portion 224 that may prevent a substantially horizontal movement of a side adjustment mechanism 114 used to adjust the dimension of the tray guide 102. For example, the tray guide 102 may include a plurality of side tray guide locks 220 to prevent corresponding side guides 104 among the plurality of side guides 104 from adjustment.

In some examples, each of the plurality of side tray guide locks 220 may couple to the side adjustment mechanism 114 of the tray guide 102. For example, the side adjustment mechanism 114 may be disposed between the top lip portion 222 and the bottom lip portion 224 of the side tray guide lock 220 when the side tray guide lock 220 is in a locked position. As such, the side tray guide lock 220 may be used individually or in combination with other tray guide locks as illustrated by FIG. 2 to prevent the adjustment of the repository area 112, thus maintaining the consistency of the dimensions of the tray guide 102. The side tray guide lock 220 as coupled and de-coupled to the side adjustment mechanism 114 is described herein in greater detail in connection with FIGS. 3A and 3B.

The side guide cover 230, as illustrated by FIG. 2, includes a first protrusion 232, a second protrusion 234, and a void 236. In some examples, the side guide cover may be used in connection with a corresponding side fastening mechanism 106 and may be referred to as a plurality of side guide covers 230. In some examples, the plurality of side guide covers 230 may conceal each of the side fastening mechanisms 106 and prevent adjustment and alteration of the dimension of the repository area 112. For example, each of the plurality of side guide covers 230 may include the first protrusion 232 and the second protrusion 234 disposed on opposite sides of the void 236 to couple each side guide cover 230 to the tray 101 when the side fastening mechanism 106 is disposed within the void 236. In this way, the side fastening mechanisms 106 may be obstructed to prevent actuation or de-actuation and thus, movement of the side guides 104.

For example, the actuation or de-actuation of the side fastening mechanisms 106 (and thus the movement of the side guides 104) may be made more difficult when the side guide covers 230 are installed over the side fastening mechanisms 106. The installation of the side guide cover 230 may indicate that the dimensions of the tray guide 102 are intended to remain unadjusted. For example, a user may be alerted that they are attempting to adjust the repository area 112 of a designated tray (e.g., the tray 101) when the side guide covers 230 conceal the side fastening mechanisms 106 to prevent actuation or de-actuation of the side fastening mechanisms 106 when pressure is applied to the side guide cover 230. As such, the side guide covers 230 may be used individually or in combination with other tray guide locks illustrated by FIG. 2 to prevent the adjustment of the repository area 112, thus maintaining the consistency of the dimensions of the tray guide 102. The side guide cover 230 as coupled to the side fastening mechanism 106 is described in greater detail herein in connection with FIGS. 3C and 3D.

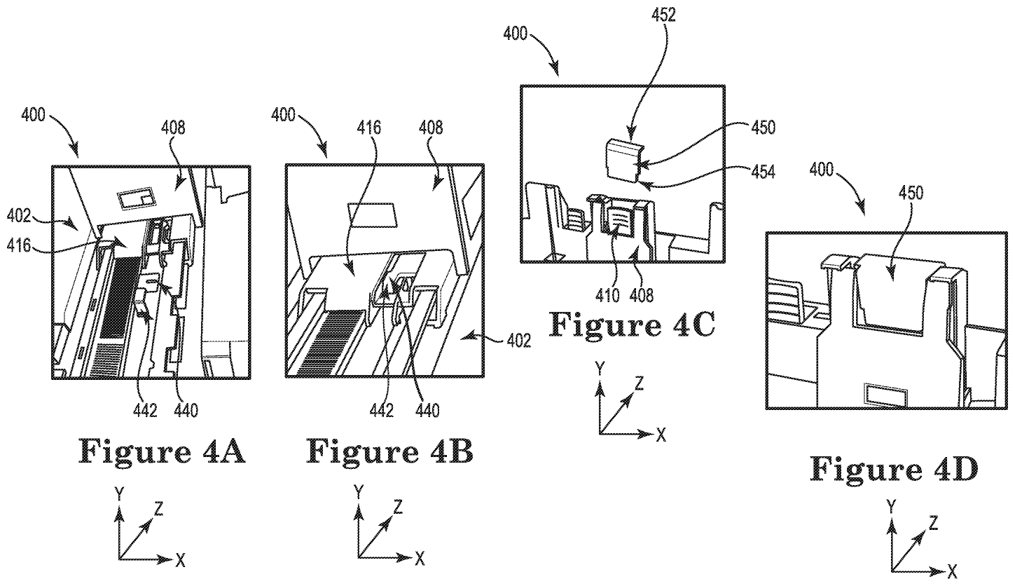

The rear tray guide lock 240, illustrated by FIG. 2 includes a head portion 242, a first foot 244 and a second foot 246. The rear tray guide lock 240 may comprise the head portion 242, the first foot 244 and the second foot 246. The rear tray guide lock 240 may prevent a substantially horizontal movement of a rear adjustment mechanism 116 used to adjust the dimension of the tray guide 102. For example, the tray guide 102 may include a plurality of rear tray guide locks 240 to prevent a corresponding rear guide 108 from adjustment. Further, each of the plurality of rear tray guide locks 240 may couple to the rear adjustment mechanism 116 of the tray guide 102. For example, the head portion 242 may be disposed under the rear adjustment mechanism 116 such that the head portion 242 is located within an aperture of the rear guide 108 of the tray guide 102 when the rear tray guide lock 240 is in a locked position. As such, the rear tray guide lock 240 may be used individually or in combination with other tray guide locks illustrated by FIG. 2 to prevent the adjustment of the repository area 112, thus maintaining the consistency of the dimensions of the tray guide 102. The rear tray guide lock 240 as coupled to the rear adjustment mechanism 116 is described herein in greater detail in connection with FIGS. 4A and 4B.

The rear guide cover 250, as illustrated by FIG. 2, includes an arm 252, and a bottom protrusion 254. The rear guide cover 250 may be to conceal a rear fastening mechanism 110 within a void 256 and prevent an adjustment and/or alteration of a dimension of the repository area 112. In some examples, the rear guide cover 250 may conceal the rear fastening mechanism 110 and prevent adjustment and alteration of the dimension of the repository area 112. For example, the rear guide cover 250 may include the arm 252, and the bottom protrusion 254, which together may form the void 256 to couple the rear guide cover 250 to the tray 101. In this way, the rear fastening mechanisms 110 may be obstructed to prevent actuation or de-actuation and thus, movement of the rear guide 108.

For example, actuation or de-actuation of the rear fastening mechanism 110 (and thus the movement of the rear guide 108) may be made more difficult when the rear guide cover 250 are installed over the rear fastening mechanism 110. The installation of the rear guide cover 250 may indicate that the dimensions of the tray guide 102 are intended to remain unadjusted. For example, a user may be alerted that they are attempting to adjust the repository area 112 of a designated tray (e.g., the tray 101) when the rear guide cover 250 conceals the rear fastening mechanisms 110 to prevent actuation or de-actuation of the rear fastening mechanisms 110 when pressure is applied to the rear guide cover 250. As such, the rear guide cover 250 may be used individually or in combination with other tray guide locks illustrated by FIG. 2 to prevent the adjustment of the repository area 112, thus maintaining the consistency of the dimensions of the tray guide 102. The rear guide cover 250 as coupled to the rear fastening mechanism 110 is described in greater detail herein in connection with FIGS. 4C and 4D.

FIG. 2 illustrates tray guide locks that may be installed individually or in combination with each other to prevent the adjustment and alteration of the tray guide 102 and the repository area 112. In this way, unintended alterations to the repository area 112 may be avoided in a tray 101 that has been designated to contain a particular size of print media as a user would first uninstall the side guide cover 230 to actuate the side fastening mechanism 106. Further, the tray guide locks described in connection with FIG. 2 may be installed without the use of tools such that the installation is easy and/or intuitive.

FIGS. 3A-3D illustrate example tray guide locks such as those shown in FIG. 2, at different instances of engagement with the tray guide (e.g., the tray guide 102). For example, FIG. 3A illustrates an example side tray guide lock at an instance of disengagement (e.g., unlocked), FIG. 3B illustrates an example side tray guide lock at an instance of engagement (e.g., locked), FIG. 3C illustrates an example side guide cover at an instance of disengagement (e.g., unlocked), and FIG. 3D illustrates an example side guide cover at an instance of engagement (e.g., locked).

FIG. 3A illustrates an example apparatus including a tray guide lock consistent with the disclosure. The apparatus 300 may include a tray guide 302, a plurality of side guides 304-1, . . . , 304-N, a side adjustment mechanism 314, side tray guide lock 320, a top lip portion 322 and a bottom lip portion 324. Although not shown in FIG. 3A for clarity and so as not to obscure examples of the disclosure, the side fastening mechanism (e.g., the side fastening mechanism 106 of FIG. 1) when actuated may permit the side adjustment mechanism 314 to move, thus moving the plurality of side guides 304 to adjust and alter the tray guide 302 and the repository area (e.g., the repository area 112).

FIG. 3A illustrates the tray side guide lock 320 in a disengaged (e.g., unlocked) position. For example, the side adjustment mechanism 314 is not disposed between the top lip portion 322 and the bottom lip portion 324 of the side tray guide lock 320. In this way, when the side fastening mechanism (e.g., the side fastening mechanism 106 illustrated in FIG. 1) is actuated, the side adjustment mechanism 314 may move to change the dimensions of the tray guide 302 by moving the plurality of side guides 304. In contrast, the side tray guide lock 320 may be engaged with the side adjustment mechanism 314 to prevent the side guide 304 from making adjustments to the tray guide 302.

FIG. 3B illustrates another example apparatus including a tray guide lock consistent with the disclosure. The apparatus 300 may include a tray guide 302, a plurality of side guides 304-1, . . . , 304-N, a side adjustment mechanism 314, side tray guide lock 320, a top lip portion 322 and a bottom lip portion 324. Although not shown in FIG. 3B for clarity and so as not to obscure examples of the disclosure, the side fastening mechanism (e.g., the side fastening mechanism 106 illustrated in FIG. 1) when actuated may permit the side adjustment mechanism 314 to move, thus moving the plurality of side guides 304 to adjust and alter the tray guide 302 and the repository area (e.g., the repository area 112).

FIG. 3B illustrates the side tray guide lock 320 in an engaged (e.g., locked) position. For example, the side adjustment mechanism 314 is disposed between the top lip portion 322 and the bottom lip portion 324 of the side tray guide lock 320. In this way, when the side fastening mechanism (not expressly pictured) is actuated, the side adjustment mechanism 314 may be prevented from moving to change the dimensions of the tray guide 302 by preventing the movement of the plurality of side guides 304. In contrast with FIG. 3A, the side tray guide lock 320 has moved in the negative x direction to engage with the side adjustment mechanism 314 to prevent the side guide 304 from making adjustments to the tray guide 302. As oriented by the coordinate plane shown in FIG. 3B, a positive x direction can refer to a direction toward the right of the page, a positive z direction can refer to a direction out of the page, and a positive y direction can refer to a direction toward the top of the page. A negative x direction can refer to a direction toward the left of the page, a negative z direction can refer to a direction into the page, and a negative y direction can refer to a direction toward the bottom of the page.

FIG. 3C illustrates an example apparatus including a side guide cover 330 consistent with the disclosure. The apparatus 300 includes a side guide 304-1, a side fastening mechanism 306 and a side guide cover 330 further including a first protrusion 332, and a second protrusion 334 to couple the side guide cover 330 to the side guide 304-1. Although not shown in FIG. 3C for clarity and so as not to obscure examples of the disclosure, the side guide cover 330 may also include a void (e.g., the void 236) to receive the side fastening mechanism 306 when in the locked position.

FIG. 3C illustrates the side guide cover 330 in a disengaged position. In some examples, the side guide cover may be disengaged (e.g., removed) to adjust the dimensions of the repository area to accommodate a different size of print media. For example, when the side tray guide lock (e.g., 320 of FIG. 3A) is disengaged, and the side guide cover 330 is removed to allow actuation or de-actuation of the side fastening mechanism 306, and wherein actuation or de-actuation of the side fastening mechanism 306 allows the print media repository area (e.g., the repository area 112) to be altered to receive print media having a different dimension (e.g., width).

FIG. 3D illustrates another example apparatus including a side guide cover 330 consistent with the disclosure. FIG. 3D illustrates an apparatus 300 including a side cover guide 330 in an engaged position where the side fastening mechanism 306 is disposed within the void (e.g., the void 236) of the side guide cover 330. In this way, the side fastening mechanism 306 is concealed and may not be easily actuated, thus preventing the alteration of the repository area (e.g., the repository area 112). In contrast with FIG. 3C, the side guide cover 330 has moved in the negative y direction to conceal the side fastening mechanism 306 within the void such that the side fastening mechanism may not be actuated.

FIGS. 3A-3D illustrates tray guide locks consistent with examples of the disclosure. The tray guide locks depicted may be installed individually or in combination with each other to prevent the tray guide 302 from being adjusted or altered. Further, the tray guide locks may be installed without the use of tools such that the installation is easy and/or intuitive. This may, for example, allow for a layman to install tray guide locks in the absence of a more sophisticated user.

FIGS. 4A-4D illustrate an example tray guide locks such as those illustrated in FIG. 2 at different instances of engagement with the tray guide (e.g., the tray guide 102). For example, FIG. 4A illustrates an example rear tray guide lock at an instance of disengagement (e.g., unlocked), FIG. 4B illustrates an example rear tray guide lock at an instance of engagement (e.g., locked), FIG. 4C illustrates an example rear guide cover at an instance of disengagement (e.g., unlocked), and FIG. 4D illustrates an example rear guide cover at an instance of engagement (e.g., locked).

FIG. 4A illustrates an example apparatus including a tray guide lock consistent with the disclosure. The apparatus 400 may include a tray guide 402, a rear guide 408, a rear adjustment mechanism 416, rear tray guide lock 440, a head portion 442. Although not shown in FIG. 4A for clarity and so as not to obscure examples of the disclosure, the rear fastening mechanism (e.g., the rear fastening mechanism 110 of FIG. 1) when actuated may permit the rear adjustment mechanism 416 to move, thus moving the rear guide 408 to adjust and alter the tray guide 402 and the repository area (e.g., the repository area 112).

FIG. 4A illustrates the rear tray guide lock 420 in a disengaged (e.g., unlocked) position. For example, the head portion 442 of the rear tray guide lock 440 is not disposed within an aperture of the rear guide 408, thus the rear guide may move to allow the alteration of the tray guide 402. In this way, when the rear fastening mechanism (not expressly pictured) is actuated, the rear adjustment mechanism 416 may move to change the dimensions of the tray guide 402 by moving the rear guide 408 in the positive or negative z direction. In contrast, the rear tray guide lock 440 may be engaged with the rear adjustment mechanism 416 to prevent the rear guide 408 from making adjustments to the tray guide 402.

FIG. 4B illustrates another example apparatus including a tray guide lock consistent with the disclosure. The apparatus 400 may include a tray guide 402, a rear guide 408, a rear adjustment mechanism 416, a rear tray guide lock 440 and a head portion 442. Although not shown in FIG. 4B for clarity and so as not to obscure examples of the disclosure, the rear fastening mechanism (e.g., the rear fastening mechanism 110 of FIG. 1) when actuated may permit the rear adjustment mechanism 416 to move, thus moving the rear guide 408 to adjust and alter the tray guide 402 and the repository area (e.g., the repository area 112).

FIG. 4B illustrates the rear tray guide lock 420 in an engaged (e.g., locked) position. For example, the rear adjustment mechanism 416 is blocked from movement because the head portion 442 is disposed within an aperture of the rear guide 408. In this way, when the rear fastening mechanism (not expressly pictured) is actuated, the rear adjustment mechanism 416 may be prevented from moving to change the dimensions of the tray guide 402 by preventing the movement of the rear guide 408. In contrast with FIG. 4A, the rear tray guide lock 440 has moved in the positive y direction to engage with the rear adjustment mechanism 416 to prevent the rear guide 408 from making adjustments to the tray guide 402.

FIG. 4C illustrates an example apparatus including a rear guide cover consistent with the disclosure. The apparatus 400 includes a rear guide 408, a rear fastening mechanism 410 and a rear guide cover 450 further including an arm 452, and bottom protrusion 454. Although not shown in FIG. 4C for clarity and so as not to obscure examples of the disclosure, the rear guide cover 450 may also include a void (e.g., the void 256) to receive the rear fastening mechanism 410 when in the locked position.

FIG. 4C illustrates the rear guide cover 450 in a disengaged position. In some examples, the rear guide cover 450 may be disengaged (e.g., removed) to adjust the dimensions of the repository area to accommodate a different size of print media. For example, when the rear tray guide lock (e.g., 440 of FIG. 4A) is disengaged, and the rear guide cover 450 is removed to allow actuation or de-actuation of the rear fastening mechanism 410, and wherein actuation or de-actuation of the rear fastening mechanism 410 allows the print media repository area (e.g., the repository area 112) to be altered to receive print media having a different dimension (e.g., length).

FIG. 4D illustrates another example apparatus including a rear guide cover consistent with the disclosure. FIG. 4D illustrates an apparatus 400 including a rear guide cover 450 in an engaged position where the rear fastening mechanism 410 is disposed within a void (e.g., the void 256) of the rear guide cover 450. In this way, the rear fastening mechanism 410 is concealed and may not be easily actuated, thus preventing the alteration of the repository area (e.g., the repository area 112). In contrast with FIG. 4C, the rear guide cover 450 has moved in the negative y direction to conceal the rear fastening mechanism 410 within the void such that the rear fastening mechanism 410 may not be actuated.

FIGS. 4A-4D illustrate tray guide locks consistent with examples of the disclosure. The tray guide locks depicted may be installed individually or in combination with each other to prevent the tray guide 402 and the repository area from being adjusted or altered. Further, the tray guide locks may be installed without the use of tools such that the installation is easy and/or intuitive. This may allow for a layman to install tray guide locks in the absence of a more sophisticated user.

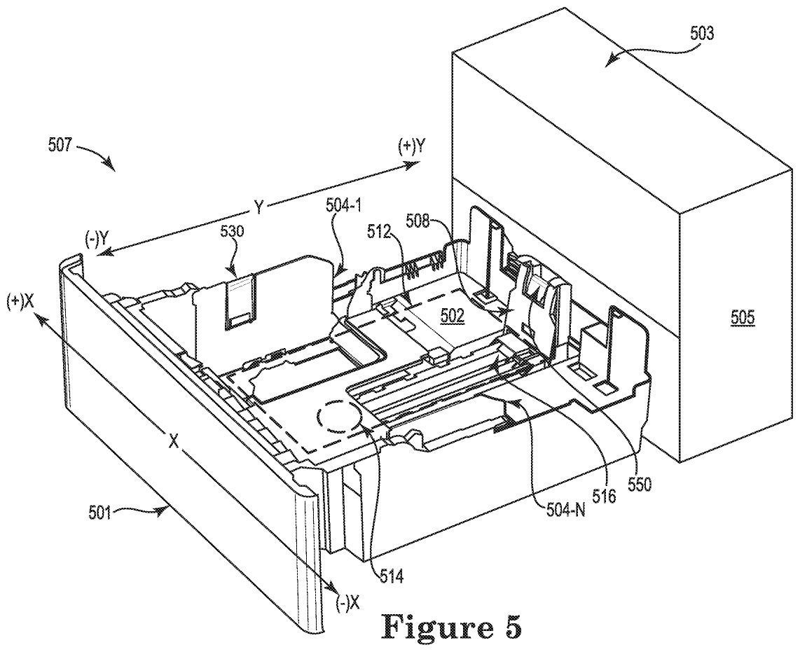

FIG. 5 illustrates an example of a system including a tray guide lock consistent with the disclosure. As shown in FIG. 5, the system 507 may include a printing device 503 including a housing 505 and/or a tray 501 disposed in the housing 505. The tray 501 may support print media. The system 507 may further include a tray guide 502 to adjust a size of a repository area 512 disposed within the tray 501, a plurality of side guides 504-1 . . . , 104-N to adjust a width of the tray guide 502 when a side fastening mechanism (e.g., the side fastening mechanism 106) is actuated, wherein adjusting the width of the tray guide 502 alters the size of the repository area 512. As used herein, the term “width” refers to the direction corresponding to the x axis as depicted in FIG. 5. Likewise, as used herein, the term “length” refers to the direction corresponding to the y axis, however, this is by way of nonlimiting example and for clarity of the descriptions.

The system 507 may further include a rear guide 508 to adjust a length of the tray guide 502 when a rear fastening mechanism is actuated (e.g., the rear fastening mechanism 110 of FIG. 1), wherein adjusting the length of the tray guide 502 alters the size of the repository area 512. The system 507 further includes a side tray guide lock (not expressly illustrated, e.g., the side tray guide lock 320) to engage the side adjustment mechanism 514 and prevent the side guides 504 from adjustment, a side guide cover 530 to conceal the side fastening mechanisms (e.g., the side fastening mechanism 106) and prevent adjustment and alteration of the width of the tray guide 502, and a rear guide cover 550 to conceal the rear fastening mechanisms (e.g., the rear fastening mechanism 110) and prevent adjustment and alteration of the length of the tray guide 502. In some examples, the system 507 may also lock the rear adjustment mechanism 516 utilizing a rear tray guide lock (not expressly illustrated, e.g., the rear tray guide lock 240).

The system 507 may include the side tray guide lock, the rear guide cover, and the side guide cover to selectively engage corresponding portions of the system 507 to prevent the alteration of the print media repository area 512. In this way, a printing device 503 that is dedicated to a particular size of print media may include a repository area 512 of consistent dimensions. Tray guide locks may improve performance of a printing device 503 by reducing errant print jobs introduced by inadvertent alteration of the print media repository area 512 by, for example, an incompetent or distracted user of the printing device 503.

Elements illustrated in the various figures herein can be added, exchanged, and/or eliminated so as to provide a plurality of additional examples of the disclosure. In addition, the proportion and the relative scale of the elements provided in the figures are intended to illustrate the examples of the disclosure and should not be taken in a limiting sense. As used herein, the designator “N”, particularly with respect to reference numerals in the drawings, indicates that a plurality of the particular feature so designated can be included with examples of the disclosure. The designators can represent the same or different numbers of the particular features. Further, as used herein, “a plurality of” an element and/or feature refers to more than one of such elements and/or features.

The above specification, examples and data provide a description of the method and applications and use of the system and method of the present disclosure. Since many examples may be made without departing from the spirit and scope of the system and method of the present disclosure, this specification merely sets forth some of the many possible example configurations and implementations.

The figures follow a numbering convention in which the first digit or digits correspond to the drawing figure number and the remaining digits identify an element or component in the drawing. Similar elements or components between different figures may be identified by the use of similar digits. For example, 102 may reference element “02” in FIG. 1, and a similar element may be referenced as 202 in FIG. 2.

What is claimed:

1. An apparatus, comprising:
a tray including a tray guide to support print media;
a plurality of side guides to adjust a dimension of the tray guide when side fastening mechanisms corresponding to each of the plurality of side guides are actuated, wherein adjusting the dimension of the tray guide alters a repository area disposed within the tray to support print media of a particular size; and
a plurality of side tray guide locks to prevent corresponding side guides among the plurality of side guides from adjustment.

2. The apparatus of claim 1, wherein each of the plurality of side tray guide locks comprise a top lip portion and a bottom lip portion that prevents a substantially horizontal movement of a side adjustment mechanism used to adjust the dimension of the tray guide.

3. The apparatus of claim 2, wherein the side adjustment mechanism of the tray guide is disposed between the top lip portion and the bottom lip portion of the side tray guide lock, when the side tray guide lock is in a locked position.

4. The apparatus of claim 1, further comprising:
a plurality of side guide covers to conceal the side fastening mechanisms and prevent adjustment and alteration of the dimension of the repository area.

5. The apparatus of claim 4, wherein each of the plurality of side guide covers includes a first protrusion and a second protrusion disposed on opposite sides of a void to couple the side guide cover to the tray when the side fastening mechanism is disposed within the void.

6. An apparatus, comprising:
a tray including a tray guide to receive a particular size of a print media in a repository area disposed within the tray;
a side guide to adjust a dimension of the tray guide when a side fastening mechanism is actuated, wherein adjusting the dimension of the tray guide alters the repository area disposed within the tray to the particular size;
a side tray guide lock to prevent the side guide from adjustment; and
a side guide cover to conceal the side fastening mechanisms and prevent adjustment and alteration of the dimension of the repository area.

7. The apparatus of claim 6, wherein the side guide lock comprises a top lip portion and a bottom lip portion that prevents a substantially horizontal movement of an adjustment mechanism used to adjust the dimension of the tray guide.

8. The apparatus of claim 7, wherein the adjustment mechanism of the tray guide is disposed between the top lip portion and the bottom lip portion of the side guide lock, when the side guide lock is in a locked position.

9. The apparatus of claim 6, wherein the side guide cover includes a first protrusion and a second protrusion disposed on opposite sides of a void to couple the side guide cover to the tray when the side fastening mechanism is disposed within the void.

10. The apparatus of claim 6, wherein the side guide cover conceals the side fastening mechanisms to prevent actuation of the side fastening mechanisms when pressure is applied to the side guide cover.

11. The apparatus of claim 6, wherein the tray further comprises:
a rear guide cover to conceal a rear fastening mechanism and prevent adjustment and alteration of the dimensions of the repository area.

12. A system, comprising:
a printing device including a housing;
a tray disposed in the housing, the tray to support print media;
a tray guide to adjust a size of a print media repository area disposed within the tray;
a side guide to adjust a width of the tray guide when a side fastening mechanism is actuated, wherein adjusting the width of the tray guide alters the size of the repository area;
a rear guide to adjust a length of the tray guide when a rear fastening mechanism is actuated, wherein adjusting the length of the tray guide alters the size of the repository area;
a side tray guide lock to prevent the side guide from adjustment;
a side guide cover to conceal the side fastening mechanisms and prevent adjustment and alteration of the width of the tray guide; and
a rear guide cover to conceal the rear fastening mechanisms and prevent adjustment and alteration of the length of the tray guide.

13. The system of claim 12, wherein the side tray guide lock is disengaged, and the side guide cover is removed to allow actuation of the side fastening mechanism, and wherein actuation of the side fastening mechanism allows the print media repository area to be altered to receive print media having a different width.

14. The system of claim 12, wherein the rear guide cover is removed to allow actuation of the rear fastening mechanism, and wherein actuation of the rear fastening mechanism allows the print media repository area to be altered to receive print media having a different length.

15. The system of claim 12, wherein the side tray guide lock, the rear guide cover, and the side guide cover are selectively engaged to prevent the alteration of the print media repository area.
